(19) United States
(12) Patent Application Publication
(10) Pub. No.: US 2016/0019288 A1
(43) Pub. Date: Jan. 21, 2016

(54) RESTRICTED ACCESS DATABASE AGGREGATES

(71) Applicant: Martin KNECHTEL, Dresden (DE)

(72) Inventor: Martin KNECHTEL, Dresden (DE)

(21) Appl. No.: 14/333,229

(22) Filed: Jul. 16, 2014

(51) Int. Cl. G06F 17/30

(52) U.S. Cl. CPC G06F 17/30604

(57) ABSTRACT

A computer-implemented method involves constituting an aggregate relation of one or more explicit relations in a computer database, each explicit relation being associated with a respective security label under a label-based access control scheme for the computer database. The computer-implemented method further involves computing a security label for the aggregate relation based on the security labels of the one or more explicit relations constituting the aggregate relation.

### TECHNICAL FIELD

This description relates to databases, which are organized collections of data, and database management systems that allow the definition, creation, querying, update, and administration of databases.

### BACKGROUND

In computing systems, databases may be thought of as electronic filing systems for organizing and storing data.

A relational database is a database that has a collection of tables of data items, all of which may be formally described and organized according to a relational model. In the relational model of a database, all data may be represented in terms of tuples, grouped into relations. Data in a single table of tuples may represent a relation. Further, the tables in a database may have additionally defined relations with each other. In contrast to a relational database, an object database (also object-oriented database management system) is a database in which information is represented in the form of objects as used in object-oriented programming.

Business or other computing systems may have databases, which include information that can be retrieved by any of a number of users. In a database management system, queries are a primary mechanism for retrieving information from a database. A query directed to a database may consist of questions presented to the database in a predefined format. Many relational database management systems use, for example, the Structured Query Language (SQL) standard query format.

A query directed to a database can be simple query by which data for a single data relationship may be retrieved from the database. An example of a simple query to a “books” database (which contains a table of book titles and authors, and a table of book titles and prices) may be: What are the titles of books with a price greater than $100? Alternatively, a query can be an “aggregate” query by which several data relationships or inter-relationships may be retrieved. An example of an aggregate query to the books database may be: What are the titles of books and what are the numbers of authors associated with each book? Another example of an aggregate query may be: What are the names of authors and what are the average prices of the books for each author?

An aggregate relation or relationship may be viewed as a relationship of relations in the data. To speed up responses to aggregate query responses, some databases may include predefined or pre-computed aggregate relationships in addition to single relationships between data items. The pre-computed aggregate relationships may, for example, enable quick query access to reports in a business data warehouse.

Consideration is now being given to database security and access control. In particular attention is directed to access control techniques for placing selective restriction on user-access to pre-computed aggregate relationships in a database.

### SUMMARY

In relational database theory, a relation may be about a ‘relationship’ that holds between data values in different domains. Each relationship may be expressed as a tuple, and a relation defined as a set of such tuples (e.g., (d1, d2, . . . , dn), where each element dj is a member of Dj, a data domain). In a computer database, a relation may be represented as a “table” (e.g., in row/column format). A tuple (e.g., a row of data items in a table) may be a set of attribute values, each attribute being identified by its name (e.g., column heading) and not by any ordinal position. A tuple by itself (e.g., a set of one tuple) may be viewed as a single-row table. For convenience in description herein, the term “relation” (or “relationship”) may be used interchangeably to refer to a table (e.g., the relationship between columns within the table), a tuple (e.g., a row in the table) or tuples. The term may also refer to relationships (e.g., links) between tables.

In a general aspect, a computer-implemented method involves constituting an aggregate relation of one or more explicitly-defined relations or relationships (e.g., one or more tuples) in a computer database. Each of the explicit tuples may be associated with a respective security label under a label-based access control scheme for the computer database. The computer-implemented method may further involve computing a security label for the aggregate relation based on the security labels of the one or more explicit relations constituting the aggregate relation.

In a further aspect, the label-based access control scheme for the computer database includes a lattice-based access control model in which objects and subjects of the computer database are represented as elements of a lattice. The method further involves computing an infimum (lattice operator [symbol] ) of the labels of the explicit relations in each alternate combination of the explicit relations that imply the aggregate relation and computing a supremum (lattice operator [symbol] ) of the infimums of all the alternate combinations that imply the aggregate relation to arrive at the label for the aggregate relation.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic illustration of an example computer database that includes a set of explicit relations and a set of aggregate relations, in accordance with the principles of the disclosure herein.

FIG. 2 is an illustration of Venn diagram of additively mixed or combined primary colors (e.g., red, blue and green colors, etc.).

FIG. 3 a schematically illustration of an example label-based access control (LBAC) scheme, which involves employing user context to limit or restrict user access to explicit and aggregate relations in a computer database, in accordance with the principles of the disclosure herein.

FIG. 4 is a schematic illustration of an example labelled database (LDB), which includes a set of explicit relations with labels and a set of aggregate relations with labels, in accordance with the principles of the disclosure herein.

FIG. 5 is a schematic illustration of a lattice representing an access level hierarchy of database tuples in a LBAC scheme, in accordance with the principles of the disclosure herein.

FIG. 6 is a schematic illustration of an example restricted access database (LDB) to which a lattice may be applied for label- or lattice-based access control, in accordance with the principles of the disclosure herein.

FIG. 7 is flow chart illustrating an example method labelling pre-computed aggregate relations in a database in manner consistent with a LBAC scheme that is used to label explicit relations in the database, in accordance with the principles of the disclosure herein.

Like reference symbols in the various drawings indicate like elements.

### DETAILED DESCRIPTION

Systems and methods for access control (e.g., read access control) of aggregate relations (“aggregates”) in computer database(s) are described herein. Using the systems and methods disclosed herein, the aggregates may be associated with labels that define visibility (e.g., for read access) of the aggregates as a function of user context. In an example business computing scenario, user context may be modeled, for example, by an algebraic structure based on user characteristics or parameters (e.g., user role, job description, experience level, level of detail, etc.). Restricting user access to authorized groups or sets of users defined by user context may encourage use of pre-computed aggregates in the database(s) for query responses. A pre-computed aggregate may be used to respond to a query from any user in an authorized group or set of users. A need to re-compute the aggregate for query responses, user-by-user, can be avoided.

The computer database(s) containing the aggregates may, for example, include one or more geographically decentralized or autonomous databases that are connected or interlinked by a computer network.

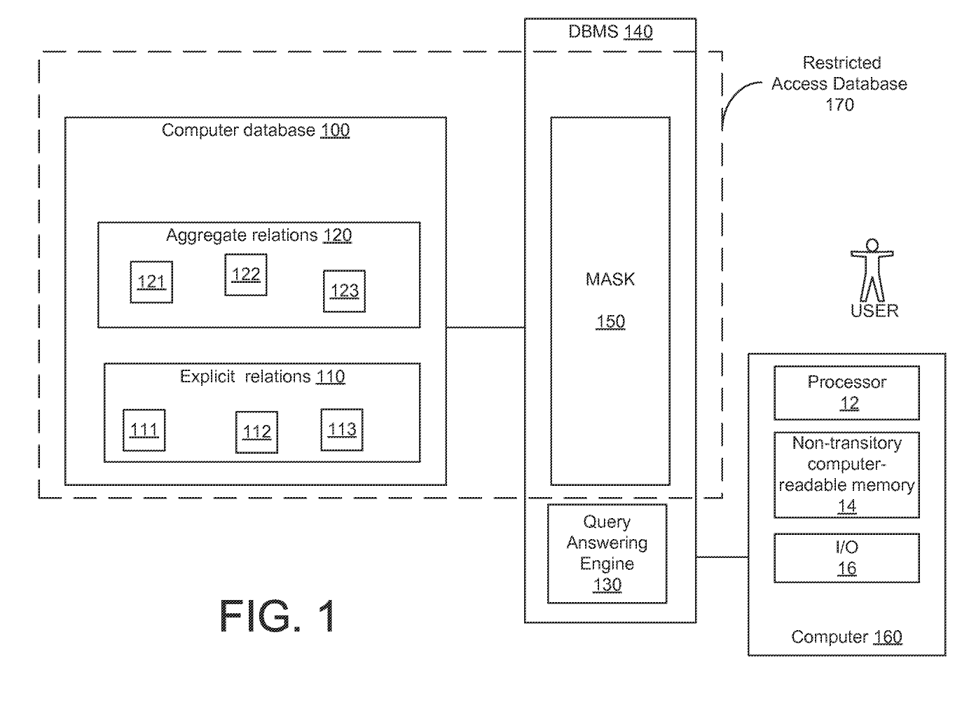

FIG. 1 shows an example computer database 100 that includes a set of explicit relations 110 (e.g., explicit relations 111, 112, and 113, etc.) and a set of aggregate relations 120 (e.g., aggregate relations 121, 122, and 123, etc.). Computer database 100 may be coupled to a database management system (DBMS) 140. DMBS 140, like computer database 100, may be hosted on a stand-alone computer or distributed on one or more physical or virtual machines in a computer network, and may be accessible to end-users via one or more user devices (e.g., laptops, netbooks, desktops, dumb terminals, smart phone, etc.) that may be wire or wirelessly linked to DMBS 140. FIG. 1 shows DMBS 140 hosted, for example, on a computer 160, which includes a processor 12, a non-transitory computer readable memory 14, and an I/O module 16. A user may interact with computer database 100 via DBMS 140 and computer 160. The user may, for example, direct queries to database 100 via DMBS 140. A database query answering engine 130, for example, in DBMS 140, may interrogate computer database 100 and provide query responses to the user.

The systems and methods for access control described herein may configure and present the computer database(s) (e.g., computer database 100) as a restricted access database (e.g., restricted access database 170) to users. The computer database(s) containing the aggregates may be transparently mapped (e.g., by DBMS 140) into a single restricted access database without actual or physical data integration. The restricted access database may mask data in the computer database(s) so that only a subset of the data appears to exist, without actually segregating data into different tables, schemas, or databases, etc. In an example business implementation, a restricted access database may constrain users (e.g., business sites, departments, individuals, etc.) to operate only on their own records and at the same time allowing more privileged users and operations (e.g. reports, data warehousing, etc.) to access, for example, to all records in the databases.

In an example configuration of the computer database(s) containing the aggregates as a restricted access database, a label-based access control (or rule-based access control) scheme may be deployed, in accordance with the principles of the present disclosure. In the label-based access control scheme, security labels (attached to data items) may be used to control access to data items (e.g., who has read access and who has write access to individual rows in a table in the database). The labels may be organized in a hierarchy of access levels. Privileges of different levels of access may be granted (e.g., by an access control administrator) to different users. The access control administrator may use any criteria to determine which users are granted which level of access (and record the privileges, for example, in an access control matrix available to DBMS 140). Access to data labeled at a certain level may be restricted and given only to users who have been granted that level of access or higher.

A lattice-based access control (LBAC) model, which may be used in the label-based access control scheme (which may also abbreviated as “LBAC”), involves multiple objects (e.g., data items, resources, computers, and applications) and/or subjects (e.g., individuals, groups or organizations) of the database. Access to objects may be determined by the interactions or relationships between any combination of labelled objects and labelled users or subjects. A lattice (“LBAC interaction lattice”) may be used to mathematically define or structure the interactions or relationships between various objects and subjects and the levels of security that an object may have and that a subject may have access to. A subject may be allowed to access an object only if the security level of the subject is greater than or equal to that of the object. The LBAC interaction lattice may have an algebraic structure representing a hierarchy of labels/access levels and may be recorded in an access control matrix available to DBMS 140.

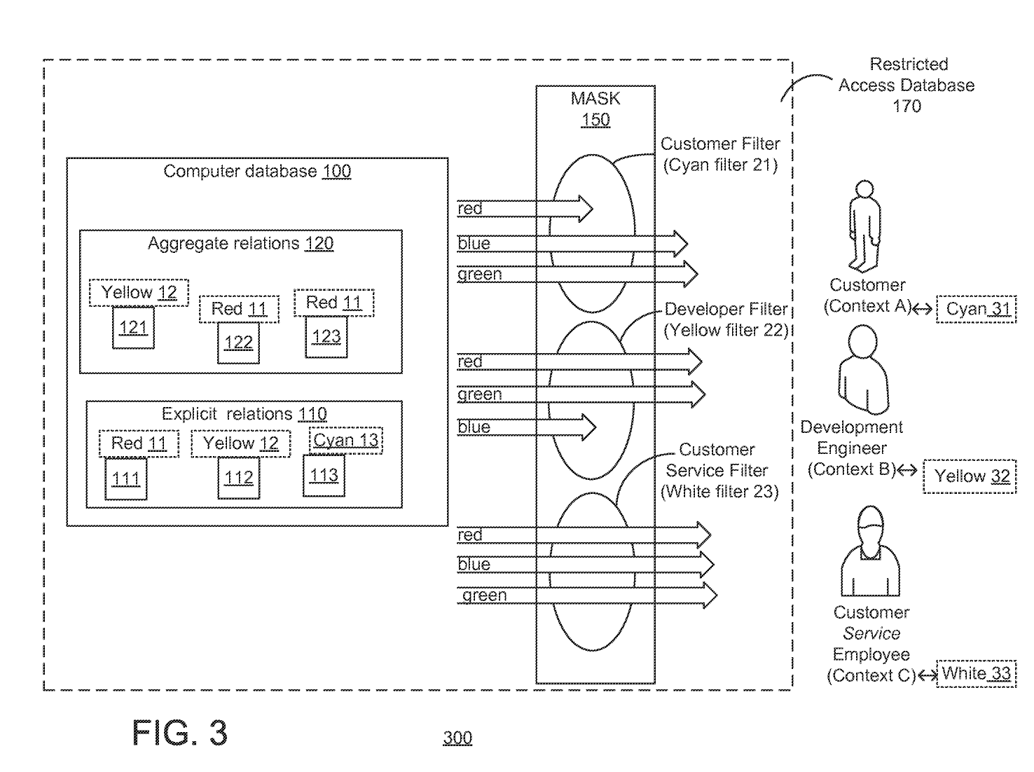

In the example configuration of the computer database(s) containing the aggregates as a restricted access database, each of the relations, explicit or aggregate, in the computer database(s) may be assigned a label or tag (“relation access level label”) that is indicative of an access level required to access (e.g., read access) the relation under the LBAC. Further, users of the computer database(s) may be categorized into one or more user contexts. Each user context may be assigned a label or tag (“user access level label”) indicative a highest access level granted to users in that user context under the LBAC. Database query answering engine 130 may interpose an adjustable mask or filter (e.g., mask 150) between users and the computer database(s) to expose only a subset of data in the computer database(s) to users. Database query answering engine 130 may, for example, use a mask 150 to control exposure of an aggregate relation to a user. Database query answering engine 130 may compare the aggregate relation access level label and the user access level label of the user context/user, with reference to the LBAC interaction lattice. If the access level granted to the user context/user is higher or equal to the access level of the aggregate relation, database query answering engine 130 may configure mask 150 to permit user access to the aggregate relation (FIG. 3). Conversely, if the access level granted to the user is lower than the access level of the aggregate relation, database query answering engine 130 may configure mask 150 to block user access to the aggregate relation (FIG. 3).

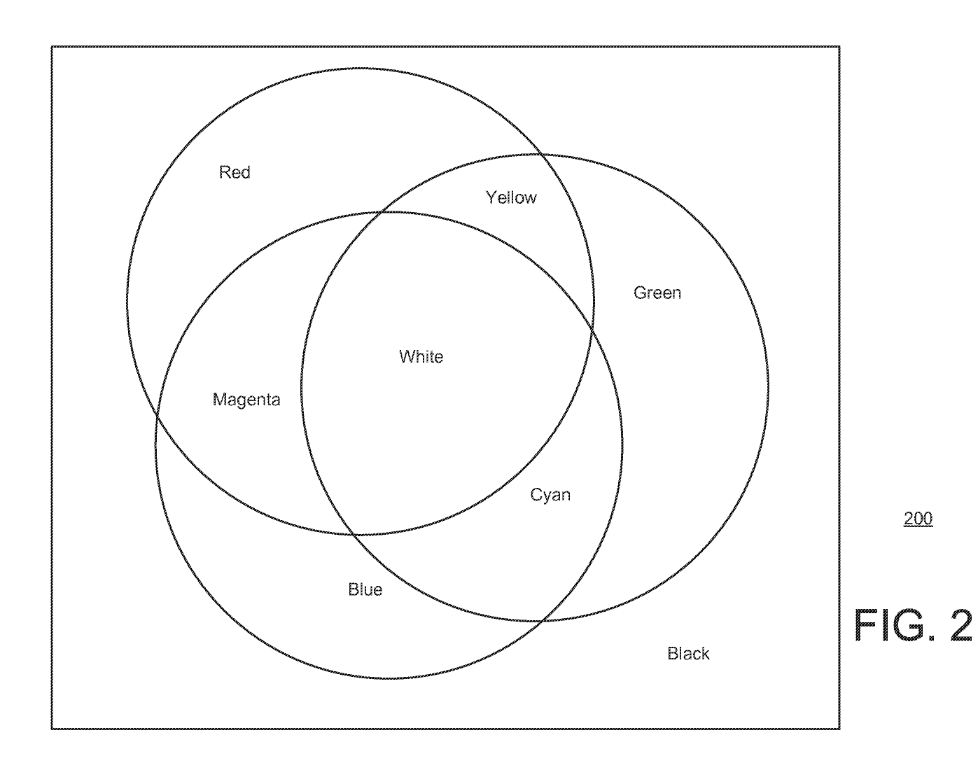

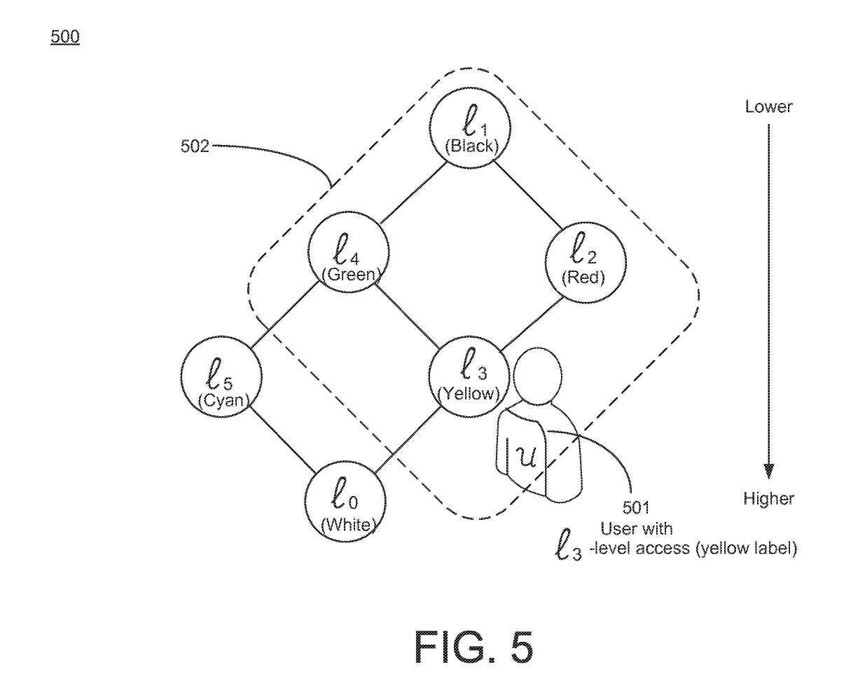

For purposes of illustration of a label comparison process of database query answering engine 130, FIG.2 shows Venn diagram 200 of additively mixed or combined primary colors (e.g., red, blue and green colors, etc.). Venn diagram 200 may be used to define an example hierarchy of labels (or access levels) in a LBAC interaction lattice (e.g., lattice 500, FIG. 5). Venn diagram 200 shows that an additive combination of red, green, and blue colors results in a white color; an additive combination of blue and green color results in a cyan color; an additive combination of green and red colors results in a yellow color; and the absence of the primary colors results in a black color. Each color shown in Venn diagram 200 may represent a label of an object or subject of a database (e.g., restricted access database 170, FIG. 3). The label comparison process for comparing a first label with a second label may involve checking whether the first label/color is contained in the second label/color. For example, cyan color contains both green and blue colors. Therefore a cyan label would have a greater value than both a blue label and a green label.

FIG. 3 schematically illustrates an example LBAC scheme 300 which involves employing user context to limit or restrict access to explicit and aggregate relations in computer database 100, in accordance with the principles of the disclosure herein.

LBAC scheme 300 may involve configuring computer database 100 as a database (e.g., restricted access database 170) by assigning respective labels to both explicit relations and pre-computed aggregate relations in the database and user contexts, and using a mask or filter (e.g., mask 150) to expose only relations having certain labels in a user context. The labels used in LBAC scheme 300 for labelling the explicit relations, aggregate relations and user contexts may, for example, be color labels based on the colors of Venn diagram 200 discussed above (FIG. 2). For example, in LBAC scheme 300, explicit relations 111, 112 and 113 in database 100 may be associated with color labels red 11, yellow 12 and cyan 13, respectively. Similarly aggregate relations 121, 122 and 123 in database 100 may be associated with color labels yellow 12, red 11 and red 11, respectively.

User contexts in LBAC scheme 300 may, for example, be based or defined by user roles (e.g., context A:user role=Customer, context B:user role=Development engineer, context C:user role=Customer service engineer, etc.). For access control of the labelled relations in database 100, each user context or role may be assigned color labels that are associated with respective color sub-masks or filters in mask 150. For example, contexts A, B and C may assigned labels cyan 31, yellow 32 and white 33 that may be associated with a cyan filter 21, a yellow filter 22, and a white filter 23, respectively, in mask 150.

The color of the sub-mask or filter may determine, by label color, which relations can be passed through or exposed in a user context. Venn diagram 200 (FIG. 2) illustrates, for example, which color filters can pass through or expose which color labels. For example, a cyan filter 21 may pass or expose only green, blue and cyan labels because those colors are contained in cyan. Thus, as shown in FIG. 3, in response to a query in user context A, cyan filter 21 may expose only relations that have a blue label or a green label (not shown) or relations (e.g., relation 113) that has a cyan label (e.g., cyan 13) but block relations (e.g., relations 111, 122 and 123) that have a red label (e.g., red 11).

Similarly, in user context B, yellow filter 22 may expose only the relations that have a green label (not shown), a yellow label (e.g., yellow 12) or a red label (e.g., red 11) but block relations that have a blue label (not shown) or a blue color component in the color of the label (e.g., cyan 13). Further, in context C, white filter 23 may expose the relations having any color label (e.g., yellow 12, red 11 and cyan 13).

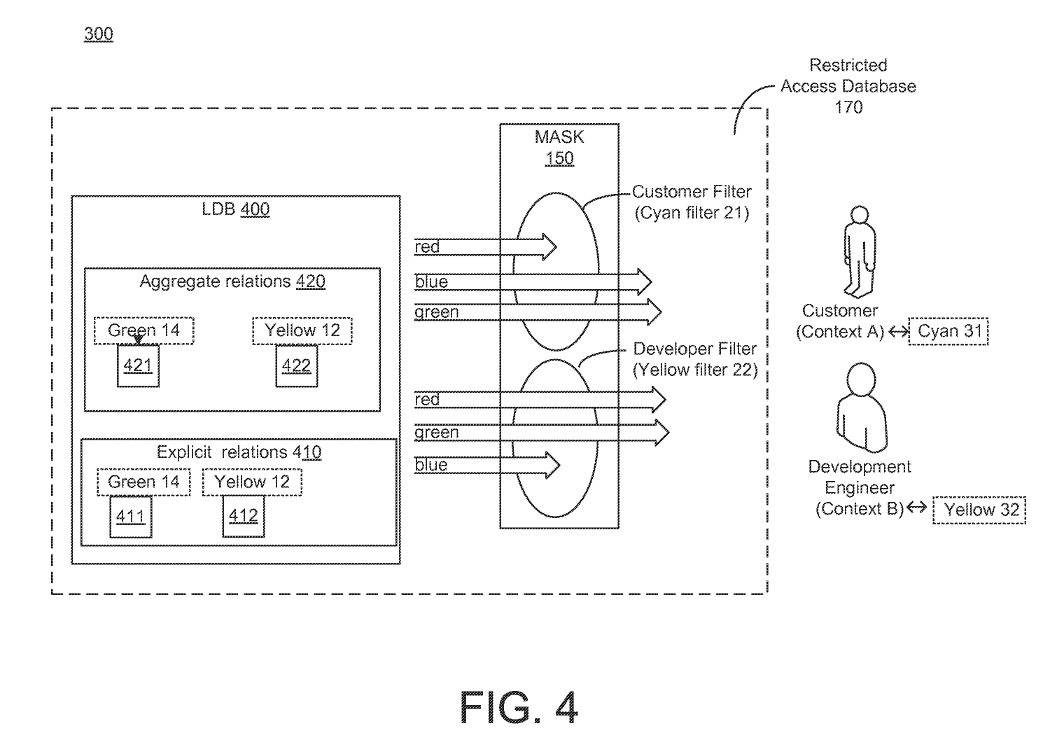

Computer databases (e.g., computer database 100, FIG. 3) that include labelled explicit and aggregate relations therein may be referred to a labeled database (LDB). FIG. 4 shows an example LDB 400, which includes a set of explicit relations (e.g., set 410) with labels (e.g., explicit relation 411 having a green label 14 and explicit relation 412 having a yellow label 12). LDB 400, may also include a set of aggregate relations (e.g., set 420) with labels (e.g., aggregate relation 421 having a green label 14 and aggregate relation 422 having a yellow label 12). An example of textual code representation (LE) of set of explicit relations 410 in LDB 400 may be
LE (410)={411: classifiedAs(ecoCalculatorV1, HighPerformance service), 412: subclassOf(HighperformanceService, LowProfitService)}

Further, an example of textual code representation (LA) of set of aggregate relations 420 in LDB 400 may be
LA (420)={421: classified As(ecoCalculatorV1, HighPerformance service), 422: classifiedAs(ecoCalculatorV1, LowProfitService)}

For LDB 400, user contexts A and B (as discussed with reference to FIG. 3, LBAC scheme 300) may be assigned color labels that are associated with respective color sub-masks or filters in mask 150. For example, contexts A and B may assigned cyan and yellow labels (e.g., cyan 31 and yellow 32) that may be associated with cyan filter 21 and yellow filter 22, respectively, in mask 150. Further (as discussed with reference to Venn diagram 200, FIG. 2, and FIG. 3) cyan filter 21 may expose only green-labelled explicit relation 411: {classified As (ecoCalculatorV1, HighPerformance service)} and green-labelled aggregate relation 421: {classified As (ecoCalculatorV1, HighPerformance service)}, to the user in user context A. Yellow-labelled explicit relation 412: {subclassOf(HighperformanceService, LowProfitService)} and aggregate relation 422: {classifiedAs(ecoCalculatorV1, LowProfitService)} may be blocked to the user in user context A. However, yellow filter 21 may expose both green-labelled explicit relation 411 and aggregate relation 421 and yellow-labelled explicit relation 412 and aggregate relation 422 to the user in user context B.

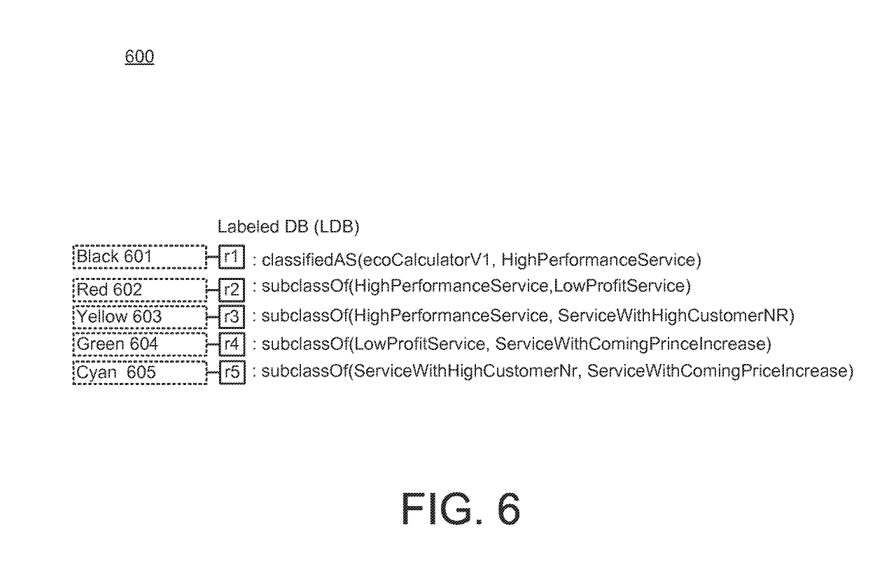

FIGS. 5 and 6 show further perspective examples of a relations lattice 500 and labelled database 600 in the context of access control processes in LBAC scheme 300, in accordance with the principles of the disclosure herein.

FIG. 5 shows an example relations lattice 500 representing a hierarchy of access levels {L: l₀, l₁, l₂, . . . l₅} in a LBAC scheme (e.g., LBAC scheme 300) that may be implemented to grant or deny users (subjects) access to relations (objects) in a database system (e.g., database system 170). As shown by the downward pointing arrow to the right of the figure, access levels higher in the hierarchy are shown toward the bottom of the figure, and access levels lower in the hierarchy are shown toward the top of the figure. The hierarchy of the access levels in lattice 500 may be based on access control rules that may be set, for example, by an access control administrator or owner of the database. For convenience in description (e.g., for ease in cross-reference with LBAC scheme 300 (FIG. 3) and LDB 400 (FIG. 4)), FIG. 5 shows an example lattice 500 in which the hierarchy and the inter-relationships of the access levels {L: l₀, l₁, l₂, . . . l₅} may be based on the additive-color rules of Venn diagram 200 used in LBAC scheme 300 and LDB 400 (discussed above with reference to FIGS. 2-4). For example, as shown by “color” names in parenthetical suffixes in the figure (e.g., “l₀ (white)”), access levels l₀, l₁, l₂, l₃, l₄, and l₅ may correspond to or be equivalent to the “white”, “black”, “red”, “yellow”, “green’ and “cyan” colors of Venn diagram 200 (FIG. 2). According to the lattice hierarchy shown, color access level l₀ (white) corresponds to a highest access level in the hierarchy because white color includes all three primary colors of Venn diagram 200. Conversely, color l₁ (black) corresponds to the lowest or no access level because black color excludes all colors of the Venn diagram 200. Color access levels l₂ (red) and l₄ (green), which are single primary colors, may correspond to an intermediate access level that is one level above the lowest color access level l₁ (black) and two levels lower than the highest color access level l₀ (white). Color access levels l₃ (yellow), and l₅ (cyan), which are an additive combination of two primary colors, may correspond to an intermediate access level which is one level lower than the highest l₀ (white) but is one level higher that the single-primary color access levels l₂ (red) and l₄ (green). Each of the color access levels (e.g., l₀ (white), l₁ (black), l₂ (red) and l₃ (yellow), l₄ (green) and l₅ (cyan)) may allow user access to different data objects in the database. For example, color access level l₃ (yellow) may authorize access to data objects (e.g., relations 111, 112, 121, 122 and 123, FIG. 3) that are associated with yellow label l₃ or a label l₁, l₂, l₄ above in the lattice, color access level l₂ (red) may authorize access to data objects (e.g., relations 111, 122 and 123, FIG. 3) that are associated with red label l₂ or label l₁ above in the lattice etc.

Under the LBAC scheme, a user (e.g., u 501) may be associated with a yellow label indicating a grant of an l₃ (yellow)-access level (based, e.g., on user context). With reference to FIG. 5, database system 170 (e.g., database query response engine 140 (FIG. 1)) may match the querying user's yellow label with the colors of the access levels in relations lattice 500 to find, for example, that the user is authorized for color access level l₃ (yellow). According to relations lattice 500, the user may also be authorized to color access levels l₁ (black), l₂ (red) and l₄ (green) that represent access levels lower than or equal to color access level l₃ (yellow) in relations lattice 500. For visual convenience, these color access levels (e.g., l₁, l₂, l₃, and l₄) are enclosed by a dotted line 502 in FIG. 5. Conversely, the user (e.g., u 501 having a yellow label) may be denied access levels l₀ (white) and l₅ (cyan)) that represent color access levels not lower than or equal to color access level l₃ (yellow) in relations lattice 500.

FIG. 6 shows an example labelled database (LDB) 600 to which a relations lattice 500 (FIG. 5) may be applied for access control. As shown, LDB 600 includes, for example, labelled explicit relations r1, r2, r3, r4, and r5. These relations r1, r2, r3, r4, and r5 may, for example, be associated with labels; Black 601, Red 602, Yellow 603, Green 604, and Cyan 605, respectively, under LBAC scheme 300. In conjunction with relations lattice 500 (FIG. 5), restricted access database 170 (e.g., database query response engine 140 (FIG. 1) may match or compare the color labels associated with relations r1, r2, r3, r4, and r5 with the color label associated with a user (e. g., u 501 having a yellow label). Database query response engine 140 may allow the user to only see or access relations r1, r2, r3 and r4 that have color labels: Black 601, Red 602, Yellow 603, and Green 604, respectively (as may be allowed under color access levels l₁, l₂, l₃, and l₄, respectively, that are the same or lower access levels in relations lattice 500 than color access level l₃ (yellow)). User u 501 may not be permitted to see relation r5 which has a cyan label (e.g., Cyan 605) (access to which may be permitted only under color access level l₅ (cyan), which is an access level not lower than or equal to color access level l₃ (yellow) in the relations hierarchy 500).

A further aspect of the disclosure herein relates to a method for pre-computing aggregate relations for a labeled database (e.g., LDB 600) containing labelled explicit relations (e.g. explicit relations r1, r2, r3, r4, and r5) and labeling the pre-computed aggregate relations for inclusion in or association with the labeled database. The explicit relations in the database may have been labelled according to a LBAC scheme. The aggregate relations may be computed or assembled, for example, by a database query answering engine (e.g., database query answering engine 140, FIG. 1) in response to aggregate queries directed to the labelled database (e.g., LDB 600). An aggregate relation may represent or be implied by one or more alternate combinations of the explicit relations in the LDB.

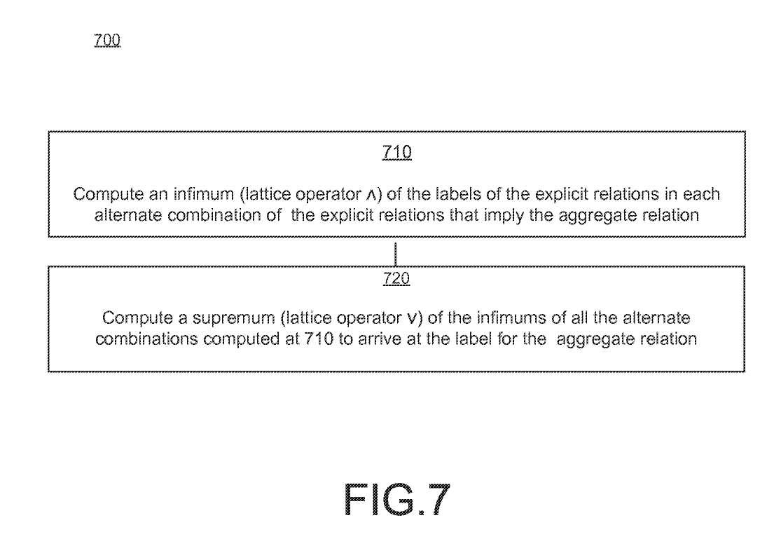

FIG. 7 shows an example method 700 for labelling the computed aggregate relations in manner consistent with the LBAC scheme used to label the explicit relations in the database. Method 700 includes computing an infimum (lattice operator [symbol] ) of the labels of the explicit relations in each alternate combination of the explicit relations that imply the aggregate relation (710) and computing a supremum (lattice operator [symbol] ) of the infimums of all the alternate combinations computed at 710 to arrive at the label for the aggregate relation (720).

### Example Pre-Computed Aggregate Relations

The operation of method 700 may be understood by application of method 700 to label example aggregate relations a1, a2, and a3 (below), which may have been pre-computed by database query answering engine 140, for example, from explicit relations r1, r2, r3, r4, and r5 in LDB 600.

a1: classifiedAs(ecoCalculatorV1, ServiceWithComingPricelncrease)

a2: classifedAs(ecoCalculatorV1, ServiceWithHighCustomerNr)

a3: classifiedAs(ecoCalculatorV1, LowProfitService)

a4: classifiedAs(ecoCalculatorV1, HighPerformanceService)

Label for Aggregate Relation a1

With reference to the labelled explicit relations r1, r2, r3, r4 and r5 (FIG. 6), aggregate a1 may be seen to be implied by the set of explicit relations (r5, r3, and r1) or alternately by the set of explicit relations (r4, r2, and r1). Taking into account the respective color labels of the explicit relations (FIG. 6), and the infimum lattice operator [symbol] (701) and the supremum lattice operator [symbol] (702) of method 700, a label value for aggregate al may be expressed in method 700 as
label a1=(r5 (cyan) [symbol] r3 (yellow) [symbol] rl (black)) [symbol] (r4 (green) [symbol] r2 (red) [symbol] r1 (black)).

Since the infimum ( [symbol] ) of cyan, yellow and black colors is white (lattice 500 and Venn diagram 200), and the infimum of green, red and black colors is yellow, the expression for label a1 may be simplified to label a1=(white) [symbol] (yellow).

Further, since the supremum of white and yellow colors is yellow, the expression for the label al may be further simplified as label a1=yellow.

Labels for Aggregates a2 and a3

With reference to the labelled explicit relations r1, r2, r3, r4 and r5 (FIG. 6) aggregates a2 and a3 may be seen to be implied by the sets of explicit relations (r3 and r1) and (r1 and r2), respectively, and the infimum lattice operator [symbol] (701), labels for aggregates a2 and a3 may be expressed by method 700 as
label a2=(r3 (yellow) [symbol] r1 (black)), and
label a3=(r2 (red) [symbol] r1 (black)).

Since the infimum ( [symbol] ) of yellow and black colors is yellow and the infimum of red and black colors is red, the expressions for labels a2 and a3 may be simplified to
label a2=yellow, and
label a3=red.

Method 700 may further include associating the labelled aggregate relations (e.g., a1 (yellow label), a2 (yellow label), and a3 (red label) with the LDB (e.g., LDB 600). The LDB including the labeled aggregate relations may be configured as a restricted access database (e.g., restricted access database 170, FIG. 1) in which user access to the labelled aggregate relations may be masked depending on the access levels granted to various user contexts based on a LBAC scheme.

The various infrastructure, systems, techniques, and methods described herein may be implemented in digital electronic circuitry, or in computer hardware, firmware, software, or in combinations of them. The implementations may be a computer program product, i.e., a computer program tangibly embodied in an information carrier (e.g., in a machine readable storage device or non-transitory medium), for execution by, or to control the operation of, data processing apparatus (e.g., a programmable processor, a computer, or multiple computers). A computer program, such as the computer program(s) described above, can be written in any form of programming language, including compiled or interpreted languages, and can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method comprising,
constituting an aggregate relation of one or more explicit relations in a computer database, each explicit relation being associated with a respective label under a label-based access control scheme for the computer database; and
computing a label for the aggregate relation based on the labels of the one or more explicit relations constituting the aggregate relation.

2. The computer-implemented method of claim 1,
wherein the label-based access control scheme for the computer database includes a lattice-based access control model in which objects and subjects of the computer database are represented as elements of a lattice, and
wherein computing the label for the aggregate relation include computing an infimum (lattice operator [symbol] ) of the labels of the explicit relations in each alternate combination of the explicit relations that imply the aggregate relation and computing a supremum (lattice operator [symbol] ) of the infimiums of all the alternate combinations that imply the aggregate relation to arrive at the label for the aggregate relation.

3. The computer-implemented method of claim 1, further comprising associating the constituted aggregate relation and its computed label as a pre-computed aggregate relation with the computer database.

4. The computer-implemented method of claim 3, wherein constituting the aggregate relation of one or more explicit relations in the computer database includes constituting the aggregate relation in response to an aggregate query directed to the computer database.

5. The computer-implemented method of claim 4 further comprising making the pre-computed aggregate relation available as a response to a next aggregate query directed to the computer database.

6. The computer-implemented method of claim 1 further comprising configuring the computer database and the aggregate relation as a restricted access database that grants user access to the aggregate relation only in a user context having privileges to an access level greater or equal to an access level associated with the computed label of the aggregate relation under the label-based access control scheme for the computer database.

7. The computer-implemented method of claim 6 further comprising comparing the computed label for the aggregate relation and a label assigned to the user context under the label-based access control scheme for the computer database to determine if the user context has privileges to an access level greater or equal to an access level associated with the computed label of the aggregate relation.

8. A system comprising:
a computing device including a processor coupled to a memory; and
a database query answering engine hosted on the computing device and coupled to a computer database containing a plurality of explicit relations, each explicit relation being associated with a respective label under a label-based access control scheme for the computer database,
the database query answering engine configured to constitute an aggregate relation of one or more explicit relations in the computer database and compute a label for the aggregate relation based on the labels of the one or more explicit relations constituting the aggregate relation.

9. The system of claim 8, wherein the label-based access control scheme for the computer database includes a lattice-based access control model in which objects and subjects of the computer database are represented as elements of a lattice, and
wherein the database query answering engine is configured to compute the label for the aggregate relation by computing an infimum (lattice operator [symbol] ) of the labels of the explicit relations in each alternate combination of the explicit relations that imply the aggregate relation and computing a supremum (lattice operator [symbol] ) of the infimums of all the alternate combinations that imply the aggregate relation to arrive at the label for the aggregate relation.

10. The system of claim 8, wherein the database query answering engine is further configured to associate the constituted aggregate relation and its computed label as a pre-computed aggregate relation with the computer database.

11. The system of claim 10, wherein the database query answering engine is configured constitute the aggregate relation in response to an aggregate query directed to the computer database.

12. The system of claim 11, wherein the database query answering engine is further configured to make the pre-computed aggregate relation available as a response to a next aggregate query directed to the computer database.

13. The system of claim 10, wherein the database query answering engine is further configured to present the computer database and the aggregate relation as a restricted access database that grants user access to the aggregate relation only in a user context having privileges to an access level greater or equal to an access level associated with the computed label of the aggregate relation under the label-based access control scheme for the computer database.

14. The system of claim 13 wherein the database query answering engine is configured to compare the computed label for the aggregate relation and a label assigned to the user context under the label-based access control scheme for the computer database to determine if the user context has the privileges to the access level greater or equal to the access level associated with the computed label of the aggregate relation.

15. A computer-program product embodied in a non-transitory computer-readable medium that includes executable code, which when executed, causes a database query answering engine to:
constitute an aggregate relation of one or more explicit relations in a computer database, each explicit relation being associated with a respective label under a label-based access control scheme for the computer database; and
compute a label for the aggregate relation based on the labels of the one or more explicit relations constituting the aggregate relation.

16. The computer-program product of claim 15,
wherein the label-based access control scheme for the computer database includes a lattice-based access control model in which objects and subjects of the computer database are represented as elements of a lattice, and
wherein the executable code when executed causes the database query answering engine to compute the label for the aggregate relation include computing an infimum (lattice operator [symbol] ) of the labels of the explicit relations in each alternate combination of the explicit relations that imply the aggregate relation and compute a supremum (lattice operator [symbol] ) of the infimums of all the alternate combinations that imply the aggregate relation to arrive at the label for the aggregate relation.

17. The computer-program product of claim 15, wherein the executable code when executed causes the database query answering engine to associate the constituted aggregate relation and its computed label as a pre-computed aggregate relation with the computer database.

18. The computer-program product of claim 15, wherein the executable code when executed causes the database query answering engine to constitute the aggregate relation in response to an aggregate query directed to the computer database and to make the constituted aggregate relation available as a response to a next aggregate query directed to the computer database.

19. The computer-program product of claim 15, wherein the executable code when executed causes the database query answering engine to configure the computer database and the aggregate relation as a restricted access database that grants user access to the aggregate relation only in a user context having privileges to an access level greater or equal to an access level associated with the computed label of the aggregate relation under the label-based access control scheme for the computer database.

20. The computer-program product of claim 15, wherein the executable code when executed causes the database query answering engine to compare the computed label for the aggregate relation and a label assigned to the user context under the label-based access control scheme for the computer database to determine if the user context has privileges to an access level greater or equal to an access level associated with the computed label of the aggregate relation.
